(19) United States
(12) Patent Application Publication
(10) Pub. No.: US 2015/0074717 A1
(43) Pub. Date: Mar. 12, 2015

(54) SYSTEMS AND METHODS FOR ENABLING AND MANAGING SOCIAL TELEVISION

(71) Applicant: WITHME, INC., Dover, DE (US)

(72) Inventors: Russ Axelrod, New York City, NY (US); Nishit Rathod, West Hills, CA (US)

(21) Appl. No.: 14/341,448

(22) Filed: Jul. 25, 2014

Related U.S. Application Data
(63) Continuation of application No. 13/773,903, filed on Feb. 22, 2013, now abandoned.
(60) Provisional application No. 61/601,750, filed on Feb. 22, 2012.

(51) Int. Cl. H04N 21/488; H04N 21/2665; H04N 21/462; H04N 21/81; H04N 21/61

(52) U.S. Cl. CPC H04N 21/4882; H04N 21/8126; H04N 21/6175; H04N 21/4622; H04N 21/2665
USPC 725/37

(57) ABSTRACT

This invention relates generally to the personal finance and banking field, and more particularly to the field of credit scoring methods and systems. Preferred embodiments of the present invention provide systems and methods for building and validating a credit scoring function based on a creditor's target information from non-traditional sources using specific algorithms.

### CROSS-REFERENCE TO RELATED APPLICATIONS

This application is a continuation of U.S. application Ser. No. 13/773,903, filed Feb. 22, 2013, which claims the benefit of U.S. Provisional Application No. 61/601,750, filed Feb. 22, 2012, which applications are hereby incorporated in their entirety by reference.

### FIELD OF THE INVENTION

The field of the invention relates to social television, and more particularly to systems and methods that enable and manage social television.

### BACKGROUND OF THE INVENTION

State of the art consumer computing devices, such as the tablet computer and the smartphone, and social networks have created a voracious appetite among television viewers for the social television experience, where viewers can interact and engage with content beyond what is shown traditionally on the television screen. For instance, while watching a television program, viewers can simultaneously receive “tweets” (from the online Twitter service) on a second screen, such as their smartphones, with commentary from one of the actors, or another person that they may follow on Twitter. In effect, the viewer would be watching the television program socially with the commentator.

Currently, these commentaries are often created in ad hoc and manual fashion and not managed or disseminated in an optimum way. Further, many of these commentaries are limited to simply text messages, such as tweets. Accordingly, an improved system for enabling and managing social television is desirable.

### SUMMARY OF THE INVENTION

The field of the invention relates to social television, and more particularly to systems and methods that enable and manage social television.

In a preferred embodiment, a central server system operably coupled to a public computer network is included. The central server system is configured to enable and manage social television and includes a receiving subsystem coupled to the public network for receiving from a host commentator a first commentary data associated with a first video program available to a plurality of television viewers. The server system further includes a commentary source subsystem having a database configured to store said first commentary data associated with the first video program. The server system also provides a user interface operably coupled to said commentary source subsystem over said public network to enable a plurality of television viewers to retrieve and watch said first commentary data in sync with said first video program.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of a preferred embodiment of the present invention;

FIG. 2a is an exemplary flowchart of a preferred electronic process of the present invention;

FIG. 2b is another exemplary flowchart of a preferred electronic process of the present invention;

FIG. 2c is another exemplary flowchart of a preferred electronic process of the present invention;

FIG. 3 is an exemplary user interface in accordance with a preferred embodiment of the present invention;

FIG. 4 is another exemplary user interface in accordance with a preferred embodiment of the present invention;

FIG. 5 is another exemplary user interface in accordance with a preferred embodiment of the present invention;

FIG. 6 is another exemplary user interface in accordance with a preferred embodiment of the present invention;

FIG. 7 is another exemplary user interface in accordance with a preferred embodiment of the present invention;

FIG. 8 is another exemplary user interface in accordance with a preferred embodiment of the present invention;

FIG. 9 is another exemplary user interface in accordance with a preferred embodiment of the present invention;

FIG. 10 is an exemplary host user interface in accordance with a preferred embodiment of the present invention;

FIG. 11 is another exemplary host user interface m accordance with a preferred embodiment of the present invention;

FIG. 12 is another exemplary host user interface m accordance with a preferred embodiment of the present invention; and

FIG. 13 is another exemplary user interface in accordance with a preferred embodiment of the present invention.

### DETAILED DESCRIPTION OF THE PREFERRED EMBODIMENTS

### Preferred Systems

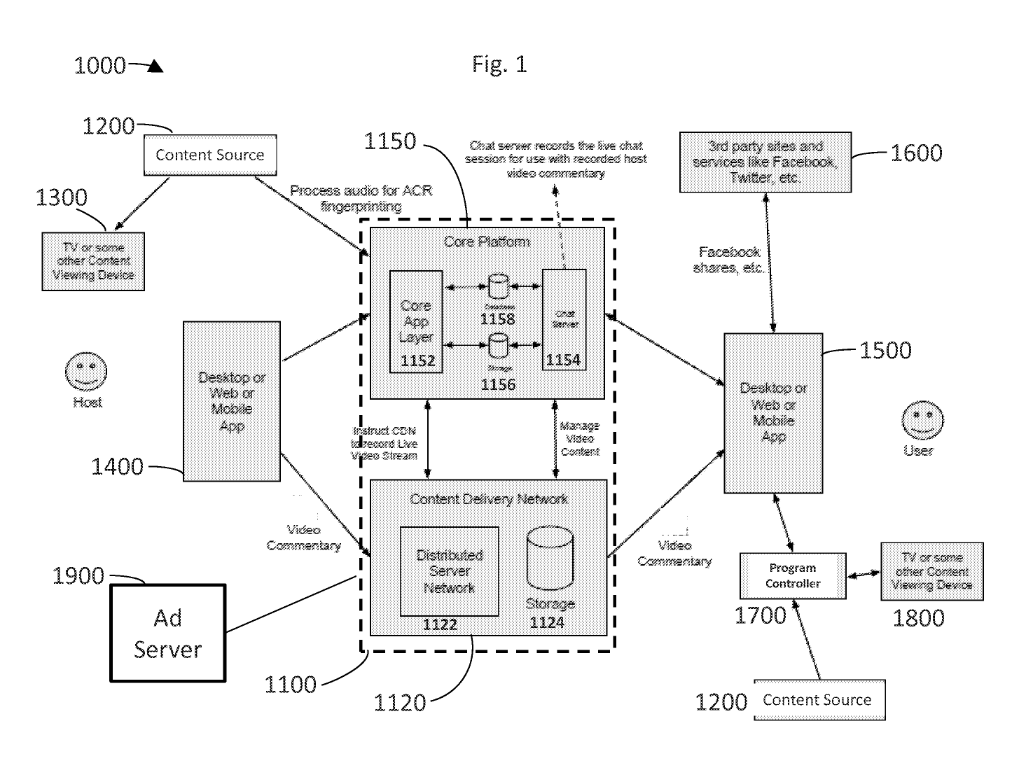

Turning to FIG. 1, a preferred system 1000 for enabling and managing commentary data for social television is shown. The system 1000 includes a central server system 1100 operating on a plurality of server machines communicatively coupled to each other via a computer network. The server machines each include a processor, memory, an operating system, an input/output interface and network interface all known in the art. The central server system 1100 provides three basic functions.

First, it receives commentary data from a “host” commentator utilizing a user interface of a client application (e.g., a desktop, web, or mobile application) 1400 over a computer network. During operation, the commentator retrieves and views media content from a third party media content source 1200 via a television or some other content viewing device 1300. The media content source 1200 may include pre-recorded content, e.g., a streaming service such as Netflix or Hulu, or a DVD. The media content 1200 may further include a live broadcasted event, such as a sporting event. While viewing the media content 1200, the commentator may provide contemporaneous commentary via the client application 1400. This commentary data may include video and/or audio recordings using a video camera (e.g., a webcam) and/or microphone, respectively, coupled to the client application 1400. Commentary data may further include text data, such as text messages and notes. Such a commentator may be a celebrity, someone with particular expertise in the content the commentator is viewing, and/or someone from the viewer's social network (such as a friend or family member), such that the viewers may desire to socially interact with the commentator while watching the same program.

The second basic function of the central server system 1100 is managing the commentary data received from the host commentators and making them searchable to the public audience over a network. There are at least two components of the preferred central server system 1100, the core platform 1150 and the content delivery network 1120. The core platform component 1150 includes a core application layer 1152 sub-component that controls the storage and distribution of the commentary data including video, audio and text message data from the commentator via the client application 1400. The core application layer 1152 further manages user profiles, authentication functionality for both the host commentators and users, purchase and redemption of credits for commentary data, reporting, etc. . . . . In a preferred embodiment, two storage systems may be used for optimum performance. Structured data, such as user account and profile information and administration information related to commentary data, such as lists of hosts and shows, may be stored in a database management system (“DBMS”) 1158 known in the art. Unstructured data, such as image and multimedia files, may be stored in a more generic storage system 1156, e.g., in files and folders. The database and storage systems may include search engine tools known in the art, such as traditional database query tools and Apache Lucene. The core platform 1150 component further includes a chat server 1154 that records live chat sessions between the host commentator via client application 1400 and one or more viewers via client application 1500. This data can be used with recorded host video commentary (explained below). This data may be synchronized with the associated content from content source 1200, e.g., using automatic content recognition (“ACR”) technology known in the art, e.g., ACR products from Audible Magic, and/or application program interfaces (“APis”) on the user's controller 1700 that allow access to timestamps within the media content being synced.

The central server system 1100 further includes a content delivery network component 1120 that records and stores video and/or audio commentary data created by the host commentator via client application 1400. Included is a storage database 1124 for storing the video commentary data and a distributed server network 1122 that manages and distributes selected video commentary for display to the user via client application 1500. The operation of the content delivery network 1120 is controlled by core application layer 1152.

The third basic function of the central server system 1100 is to retrieve and present selected commentary data to the user via its client application 1500 (e.g., desktop, web, television, or mobile application). In operation, the user selects a particular media content from 3rd party media content source 1200, retrieved by a controller device 1700 (e.g., a DVR unit, SmartTV, Apple TV) to display on the viewer's television or viewing device 1800. If the user desires to play certain commentary data from a host commentator in sync with the selected content, the user may utilize client application 1500 to search for, select, and retrieve the desired commentary data, e.g., video, audio, and/or text messaging data. The commentary data may then sync with the content played on viewing device 1800 using ACR or an available API on controller 1700 to retrieve time stamp data from the selected media content. This API may be accessible to client application 1500, e.g., over a local area network and/or wifi connection. This API may further enable the client application 1500 to select the channel that displays the desired media content on viewing device 1800. The client application 1500 may further enable the viewer to share the viewer's social interaction with a third party social network 1600, such as Facebook or Twitter.

Further, server system 1100 may be operably coupled to an advertisement server 1900 via a public network. Based on the information retrieved by server system 1100 from either the host commentators via client application 1400 or the viewers via client application 1500, e.g. relevant content within the commentary data recorded or played, targeted ads may be generated by the advertisement server 1900 for display on the respective client applications 1400/1500. In the alternative configuration, the advertisement server 1900 may be integrated into server system 1100 and operatively coupled to core platform 1150 and controlled and managed by core application layer 1152.

### Preferred Processes

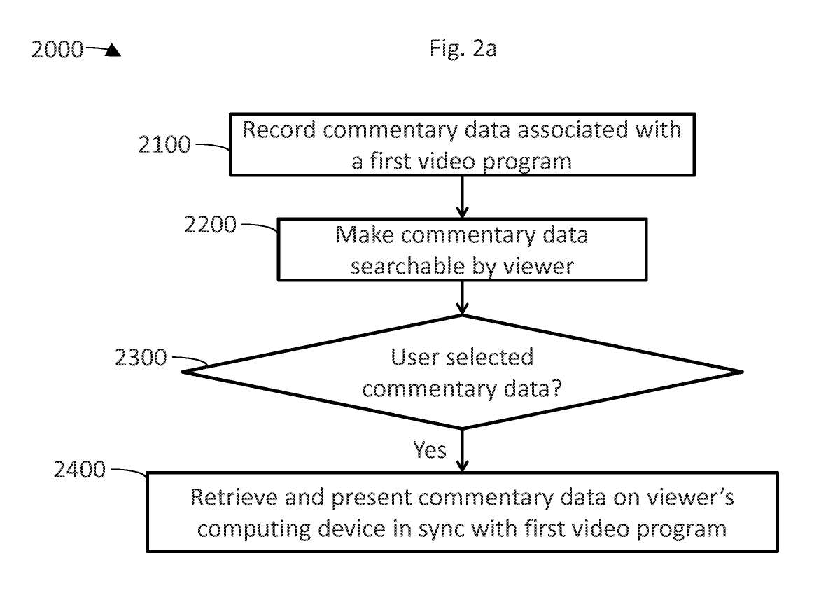

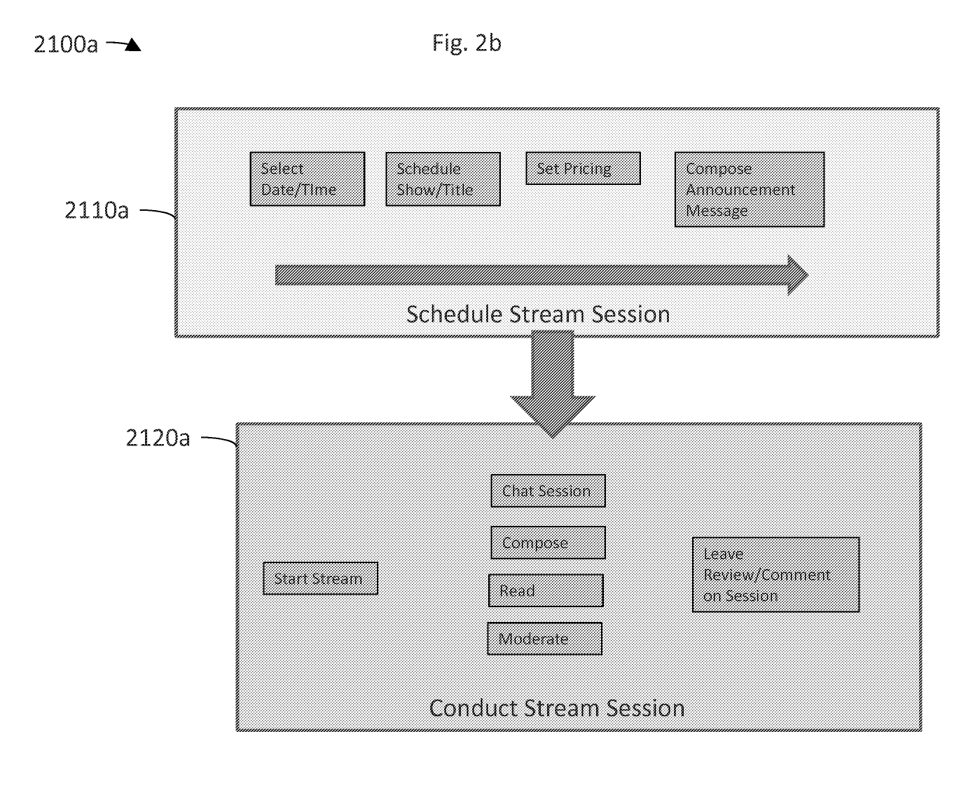

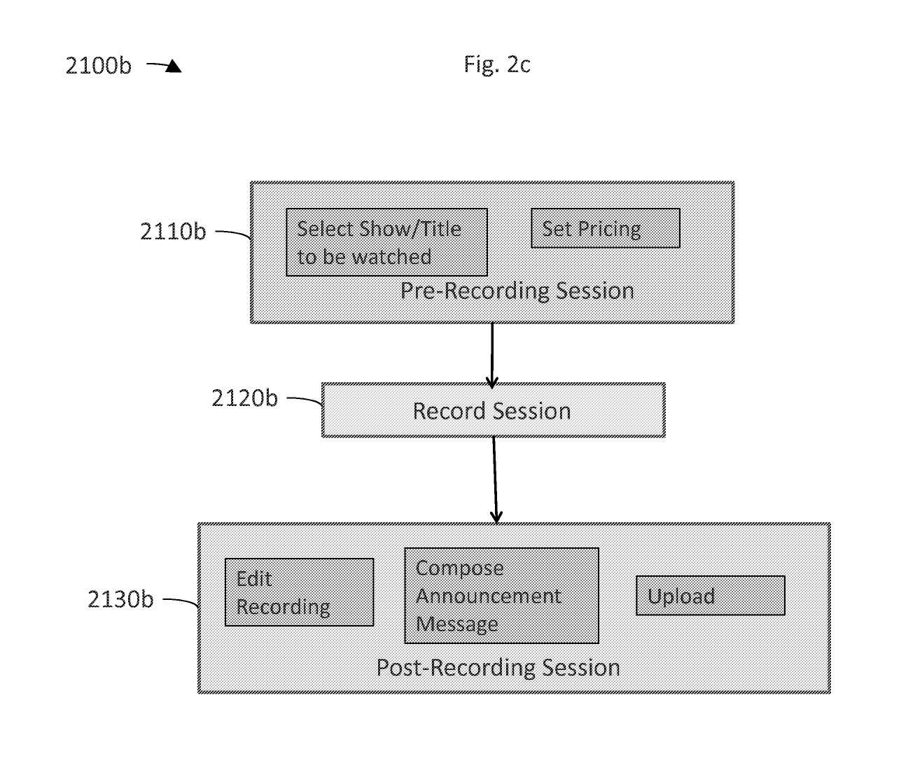

Turning to FIG. 2a, a preferred electronic computer based process 2000 is shown using system 1000. A host commentator may create commentary data for a particular video program (Action Block 2100). This commentary data is created using client application 1400 and may include video using a video camera (e.g., a webcam) and/or audio using a microphone, as well as text data, such as interactive chats with users as well as text data logged contemporaneously with the host commentator's viewing of the associated media content 1300. Such data may include time stamps to enable the data to be played on client application 1500 in sync with content played by user on device 1800. Optionally, an authentication component may be added to provide security.

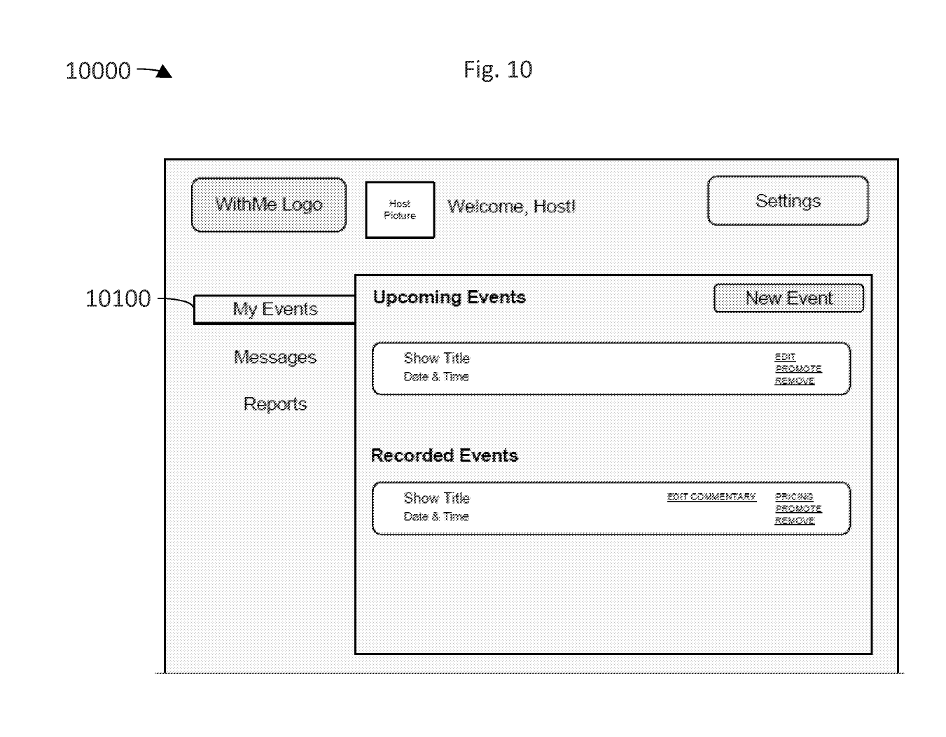

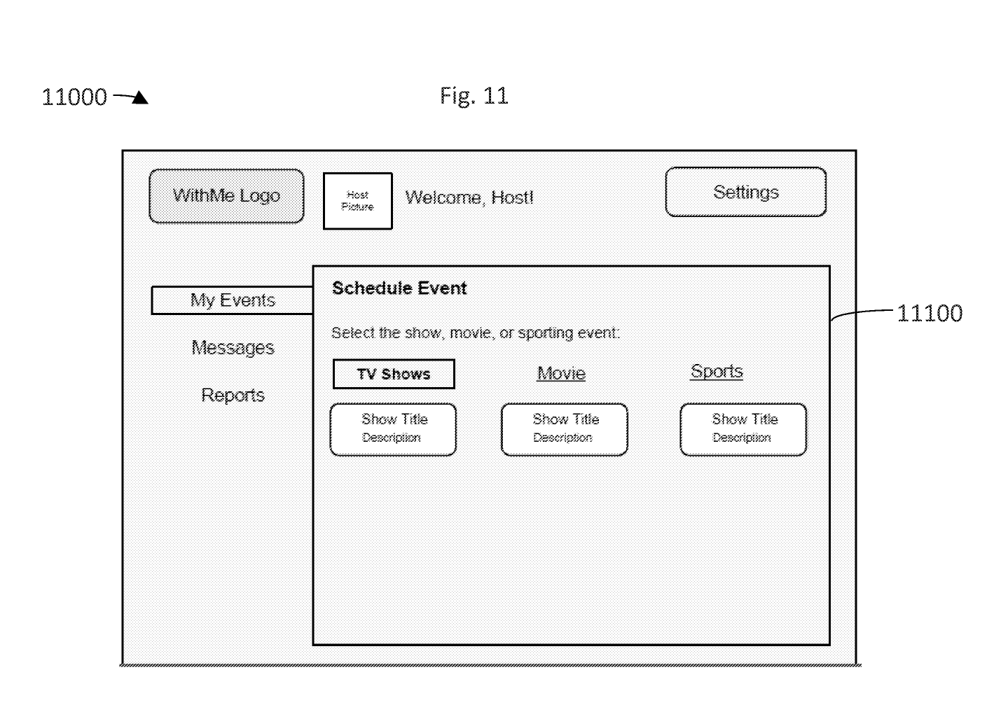

Turning to FIG. 10, an exemplary user interface 10000 for the host client application 1400 is shown. The user interface 10000 may include the host's picture and identify the commentary data created by the host commentator and/or scheduled events to create commentary data 10100. The host commentator may also set a price for the commentary data created to create a marketplace-exchange with system 1000. Turning to FIG. 11, another exemplary user interface 11000 for the host client application 1400 is shown. This user interface 11000 enables the host commentator to select the type of media event to create commentary data for 11100. For instance, the host commentator may select pre-recorded media content to comment on such as tv shows or movies, or a live media event, such as a sporting event.

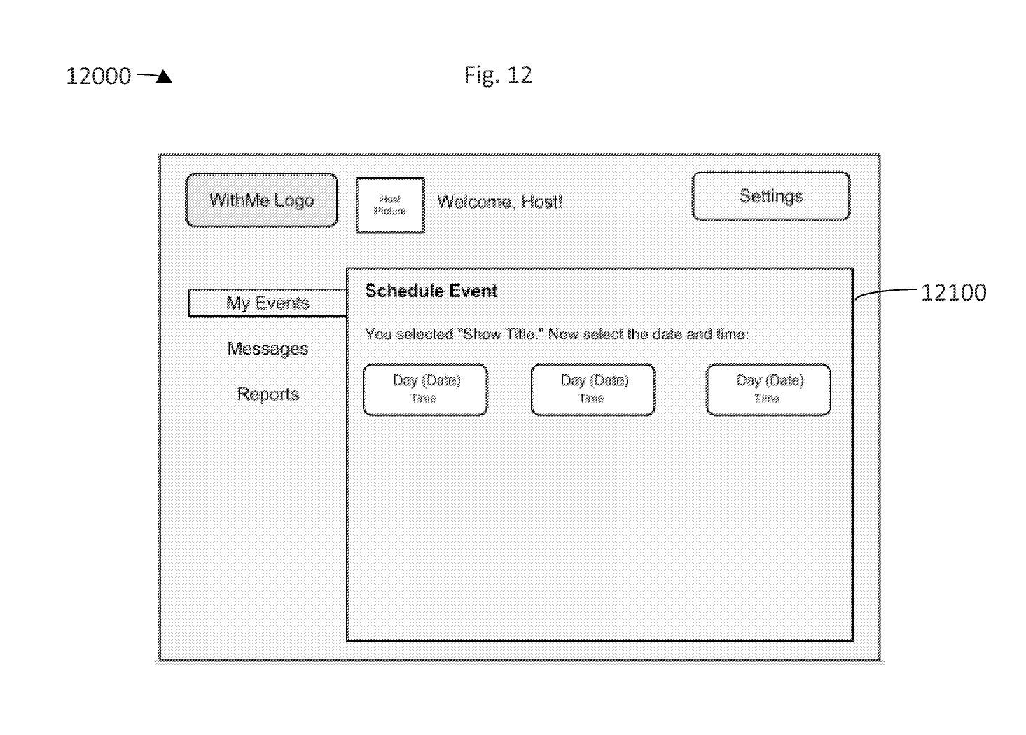

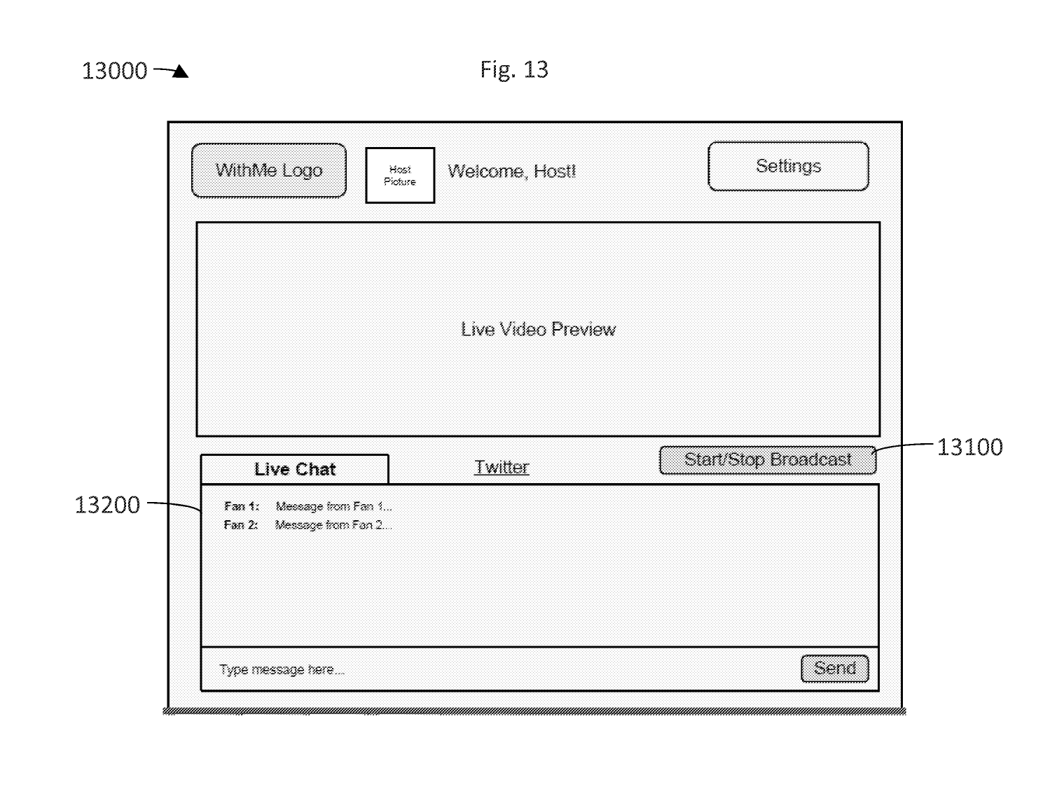

Turning to FIG. 2b, an electronic process for creating commentary data for a live media event is shown 2100a. For live media events, a session for creating commentary data is scheduled (Action Block 2110a). Turning to FIG. 12, an exemplary user interface 12000 for host client application 1400 is shown for scheduling a media event. The host may select the date and time 12100 and the title of the event. The host commentator may also set a price for purchase and also compose an announcement message to notify potential viewers. When the live media event begins, the host commentator initiates the creation of its commentary data (Action Block 2120a). Turning to FIG. 13, an exemplary user interface 13000 for host client application 1400 is shown for creating commentary data. With a video camera (e.g., a webcam) and/or microphone coupled to the host client application 1400 (not shown), a host commentator may initiate a video and/or audio recording while watching the media event (e.g., through device 1300) to record commentary data with button 13100. The host commentator may also view the recording with the “Live Video Preview” panel. For a live media event, such commentary data would also be broadcasted to its viewers. Live chat with participating viewers, via chat server 1154, is also available in panel 13200. Offline messages can also be composed and read, and other sessions may be moderated, as shown in FIG. 2b.

Turning to FIG. 2c, an electronic process for creating commentary data for pre-recorded media is shown 2100b. The host commentator may select the show to be watched and pricing for commentary data created (Action Block 2110b), e.g., through user interfaces 10000 and 11000, as shown in FIGS. 10 and 11, respectively. A session can then be recorded (Action Block 2120b), e.g., using a video camera (e.g., webcam) or microphone for video and/or audio commentary. After the commentary data has been recorded, the host commentator may further edit and upload the data for viewers' access and may also notify viewers of its availability (Action Block 2130b).

The created commentary data is then stored in the central server system 1100 for selection and retrieval by a user (Action Block 2200). The commentary data is generally stored and managed by core platform 1150. To provide faster retrieval and delivery response time, the content delivery network 1120 is utilized. For video-based and audio-based commentary data, such data may be transcoded into a variety of file formats and bit rates known in the art, e.g., MPEG, Quicktime, Windows Media, Real Media and Flash, to support a wide range of devices on which client application 1500 is operating, e.g., smartphones, tablets, desktop computers, and televisions, and to support a wide range of client network conditions, e.g., wifi, cellular, or local area network connections. Such transcoding functionality may be included in content delivery network 1120. For text-based commentary data, such data may be stored in a traditional DBMS 1158 or any other storage system that allows for queries and efficient access to text-based data generally. The DBMS 1158 may further include information about the commentary data stored in system 1100 generally, e.g., names of hosts, associated shows and episodes, etc. . . .

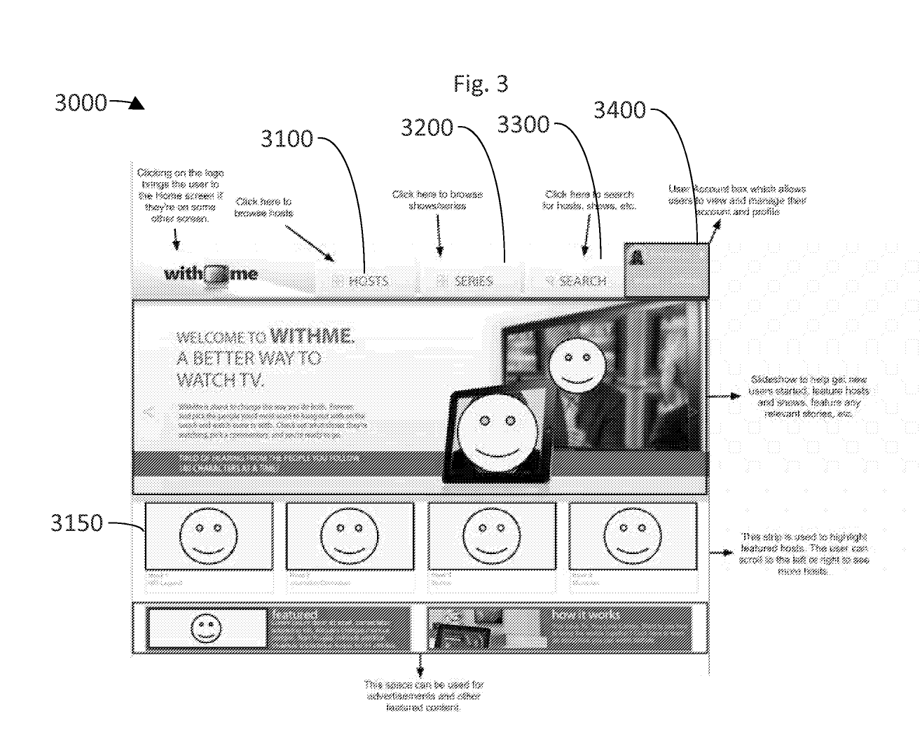

Turning to FIG. 3, an exemplary user interface 3000 for client application 1500 is shown that enables a user to search for and select desired commentary data. The user interface 3000 allows the user to select commentary data by a particular host 3100, particular content 3200, and/or by a keyword search 3300. A user may set up a secure account 3400 with authentication to enable the user to set up a profile with preferences that enable system 1100 to provide notifications to events and content that may interest the user. The account may also enable the purchase and redemption of credits for desired commentary data, and the engagement in an interactive chat session with a host commentator via chat server 1154. The user interface 3000 may also select from a short list of featured hosts 3150 or popular hosts based upon its historical usage and/or popular selections from other users. Such data can be retrieved from database 1158.

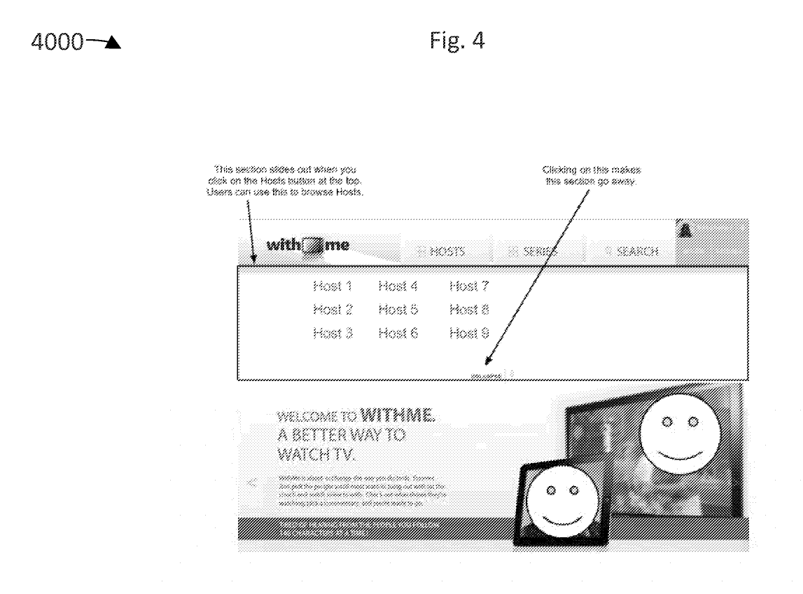

Turning to FIG. 4, an exemplary user interface 4000 is shown if the user searches for commentary data by “host” 3100, which can be organized by expertise, popularity, and/or alphabetical order. Such data can also be retrieved from database 1158.

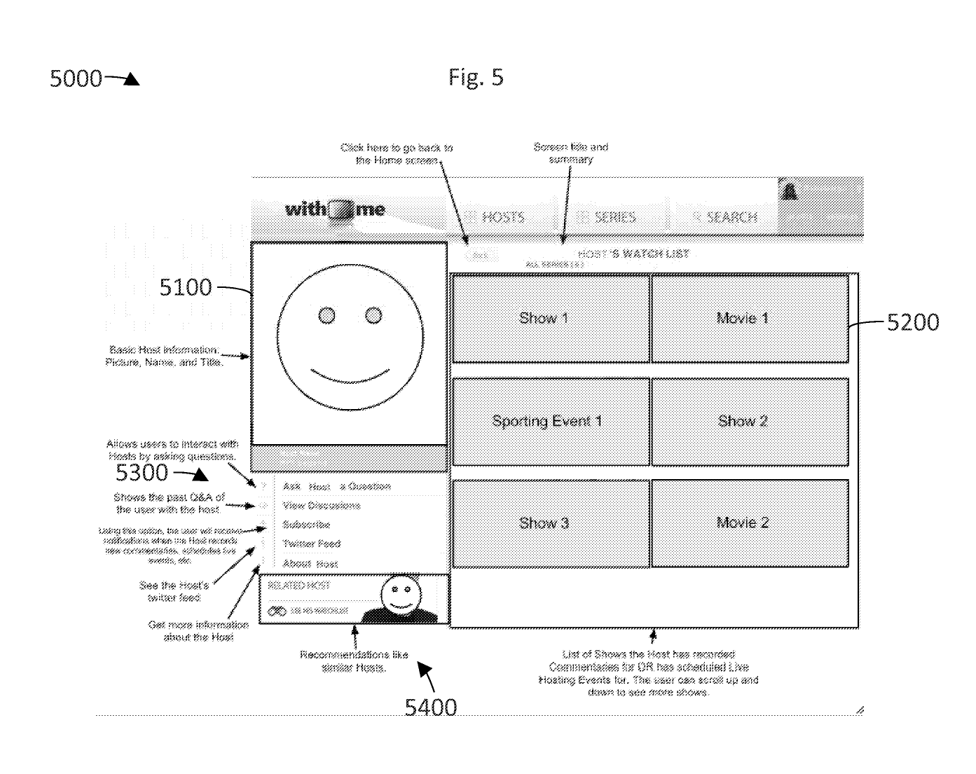

Turning to FIG. 5, an exemplary user interface 5000 is shown if a particular host is selected. The host's profile is shown, including picture 4100 and the media content that the host commentator has recorded commentary data for 5200, e.g., particular shows and sporting events which can be scrolled up or down. Also included in the host's profile are relevant data to facilitate the user's selection 5300. Such data may include previous chat discussions, twitter feeds, information about the host, such as background, the ability to send the host questions, and the ability to subscribe to and purchase the host's commentary data and/or receive notifications of upcoming events involving the host commentator or new material recorded by the host. The user interface 5000 may also include a link to other hosts or recommendations similar to the selected host 5400.

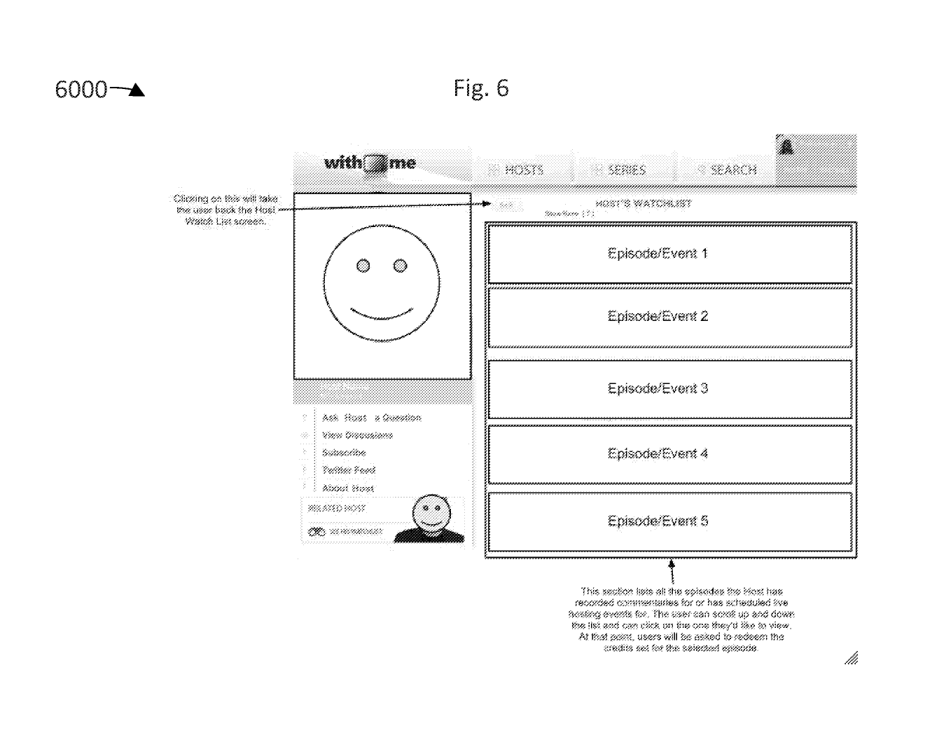

Turning to FIG. 6, a user interface 6000 is shown if the user selected a particular show or event for a host that includes multiple episodes or events with commentary data that the user may choose from.

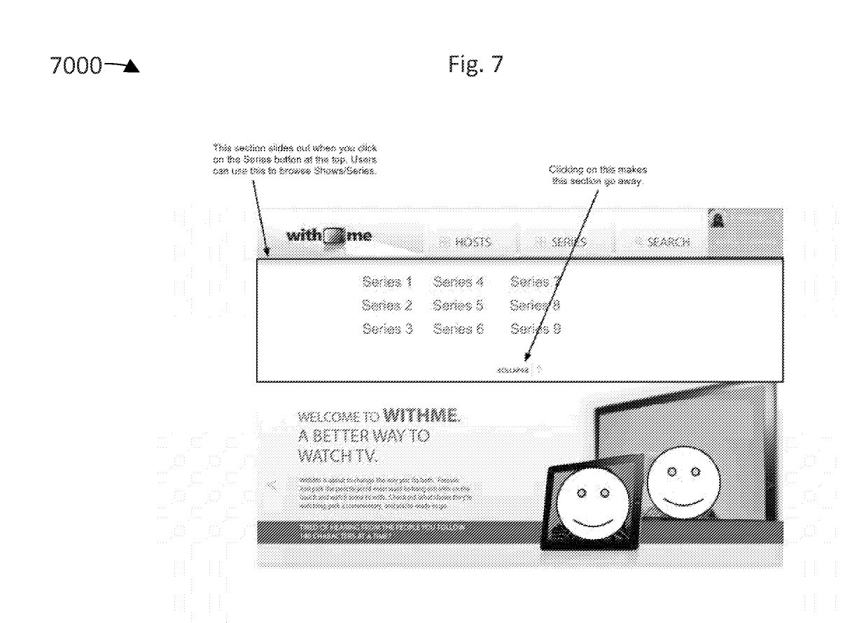

Turning to FIG. 7, a user interface 7000 is shown if the user wishes to search for commentary data by event or show instead of by host. What is listed is a set of shows with associated commentary data, which may be created from among one or more different host commentators.

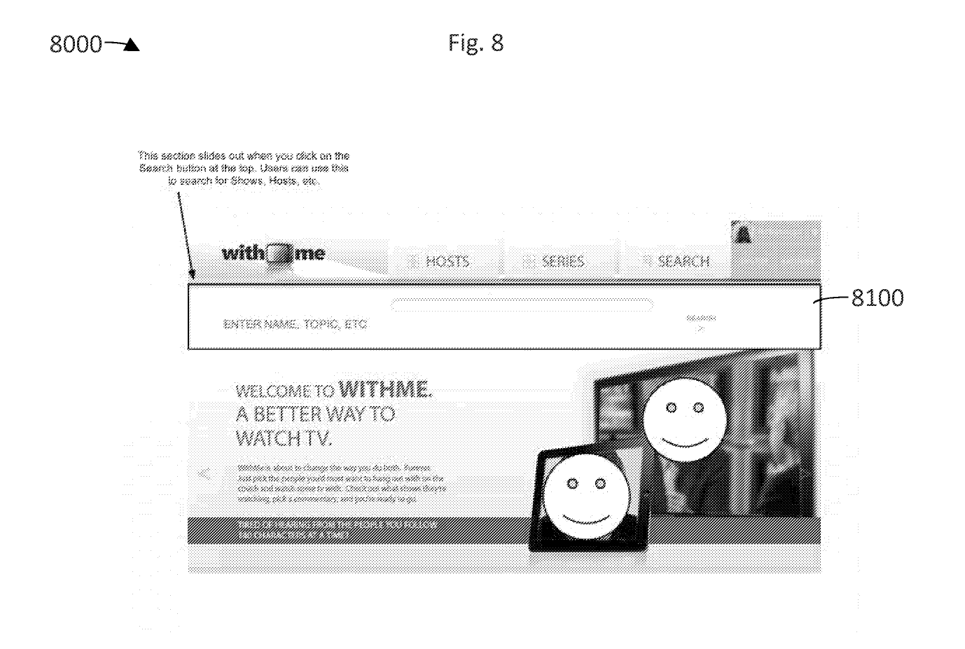

Turning to FIG. 8, a user interface 8000 is shown if the user wishes to search for commentary data using the keyword search option 8100. The client application 1500 may also identify what program the user is currently viewing in viewing device 1800, e.g., through ACR or an API in controller 1700 and identify the commentary data available for the media content currently being viewed. Client application 1500 can make the commentary data available for selection and purchase.

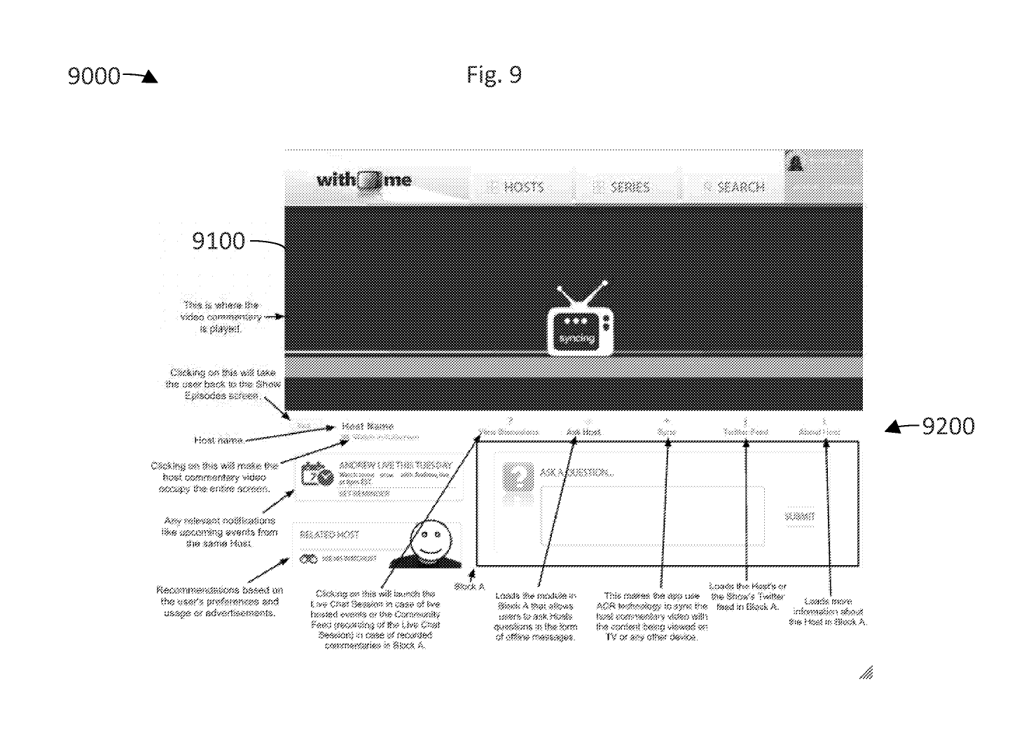

Turning back to FIG. 2a, if the user has selected particular commentary data, e.g., using the interfaces described above (Decision Block 2300), then the system 1100 retrieves the selected commentary data from its databases (e.g., 1124, 1158, 1156) and pushes the selected content to client application 1500 for presentation to the user (Action Block 2400). Turning to FIG. 9, a user interface 9000 is shown for presenting selected commentary data. A media player 9100 is included for playing video and/or audio commentary. The user may sync the commentary with the media content playing on the viewing device 1800 using one of the options shown in 9200. This sync may be achieved using ACR technology, which enables the client application 1500 to identify the show being played on the viewer's device 1800 as well as the position within the show. Alternatively, the sync may be achieved by accessing the media content's timestamp using an API provided by program controller 1700, e.g., through a wifi or local area network connection. This API may enable client application 1500 to determine what show is being played on device 1800 and the current position in the show. The API may further enable the client application 1500 to determine what other content is available on the user's display device 1800 and also act as a remote control to controller 1700.

In addition to video and/or audio commentary, text-based commentary may also be displayed, e.g., through a twitter feed and/or a chat session (“View Discussions”), which will show live text messages for live hosted events or a community feed for pre-recorded events. The user may also interact with the host commentator, if available “(Ask Host”). Such discussions can also be archived in core platform 1150 database 1158 for other viewers to view. As can be appreciated by one of ordinary skill in the art, more than one type of commentary data and commentary data from multiple host commentators can be viewed simultaneously. Moreover, commentary data may be viewed not only on the user's second computing device, such as computer or smartphone, but the data may also be viewed on viewing device 1800 along with the media content from content source 1200.

Other interactive features may be included, e.g., quizzes or interactive games. For instance, during advertisement breaks in the media content, questions could be asked based on what happened in the previous segment shown and rewards (physical or virtual) may be provided for correct answers (not shown). An e-commerce system can also be included, where products having relevance to what is being shown either in the media content or commentary data (e.g., products shown or discussed with the commentator) may be displayed along with links for purchase by the user.

The systems and processes described above may enable seamless posts and selections of commentary data for 3rd party media content in a marketplace exchange.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for management of commentary data for social television but may be applicable to management of commentary data for any type of media content. For instance, a medical expert may serve as a host commentator for pre-recorded medical procedures; an expert may provide commentary data for a pre-recorded classroom lecture; or a former player or coach may provide commentary data for a sporting event or practice. Additionally and obviously, features may be added or subtracted as desired. Accordingly, the invention is not to be restricted except in light of the attached claims and their equivalents.

What is claimed is:

1. A computer system operably coupled to a public computer network and configured to enable and manage social television comprising:
a receiving subsystem coupled to the public network for receiving, from a first host commentator, first commentary data associated with a first video program available to a plurality of television viewers;
a commentary source subsystem operably coupled to the receiving subsystem and having a database configured to store said first commentary data associated with the first video program; and
a user interface operably coupled to said commentary source subsystem over said public network that enables a television viewer to retrieve and play said first commentary data in sync with said first video program.

2. The computer system of claim 1, wherein the user interface is a software application configured to operate on a mobile device.

3. The computer system of claim 1, wherein the user interface is a software application configured to operate on a device that is also displaying the first video program.

4. The computer system of claim 1, wherein said first commentary data, when played, is synchronized with said first video program using an automatic content recognition system.

5. The computer system of claim 1, wherein the first video program is a live broadcast event.

6. The computer system of claim 1, wherein the first video program is a pre-recorded video program.

7. The computer system of claim 1, wherein the first commentary data may include one or more of: text messages, video recordings, and audio recordings.

8. The computer system of claim 1, wherein said user interface is enabled to play commentary data from multiple host commentators simultaneously.
